(19) United States
(12) Patent Application Publication
(10) Pub. No.: US 2023/0214387 A1
(43) Pub. Date: Jul. 6, 2023

(54) Techniques for Tiered Cache in NoSQL Multiple Shard Stores

(71) Applicant: International Business Machines Corporation, Armonk, NY (US)

(72) Inventors: Peng Hui Jiang, Beijing (CN); Gang Tang, Nanjing (CN); Jun Su, Beijing (CN); Yan Chen, Beijing (CN); Yun Wei Qi, Shanghai (CN)

(21) Appl. No.: 17/647,077

(22) Filed: Jan. 5, 2022

(51) Int. Cl. G06F 16/2453; G06F 16/2457; G06F 16/248; G06F 16/23

(52) U.S. Cl. CPC G06F 16/24539; G06F 16/24575; G06F 16/248; G06F 16/2322

(57) ABSTRACT

Computer technology for: (i) performing prefetching based on shard workload in NoSQL; and/or (ii) perform distribution of stored data over the various tiers of a cache memory based on shard workload in NoSQL. This can help achieve better load balance among and between the shards of a database and the respectively associated nodes on which the shards are stored.

### BACKGROUND

The present invention relates generally to the field of tiered caches, and more particularly to data stores (for example, databases) that use shards.

The Wikipedia entry for “database shard” as of 9 Dec. 2021 states, in part, as follows: “A database shard, or simply a shard, is a horizontal partition of data in a database or search engine. Each shard is held on a separate database server instance, to spread load. Some data within a database remains present in all shards, but some appears only in a single shard. Each shard (or server) acts as the single source for this subset of data . . . . Horizontal partitioning is a database design principle whereby rows of a database table are held separately, rather than being split into columns (which is what normalization and vertical partitioning do, to differing extents). Each partition forms part of a shard, which may in turn be located on a separate database server or physical location. There are numerous advantages to the horizontal partitioning approach. Since the tables are divided and distributed into multiple servers, the total number of rows in each table in each database is reduced. This reduces index size, which generally improves search performance. A database shard can be placed on separate hardware, and multiple shards can be placed on multiple machines. This enables a distribution of the database over a large number of machines, greatly improving performance. In addition, if the database shard is based on some real-world segmentation of the data . . . then it may be possible to infer the appropriate shard membership easily and automatically, and query only the relevant shard.” (footnotes omitted)

Prefetching and caching are well-known techniques integrated in database engines and file systems in order to speed-up data access. They have been studied for decades and have proven their efficiency to improve the performance of I/O intensive applications. In NoSQL (not only structured query language), large datasets are broken into smaller ones, and stored into multiple nodes. The CRUD (Create, Read, Update, Delete) load and query load on those datasets are distributed to multiple nodes to achieve high scalability. In other words, if a dataset becomes very large for a single node or when high throughput is required, a single node does not suffice. The arises a need to partition/shard such datasets into smaller chunks and then each partition can act as a database on its own. Thus, a large dataset can be spread across many smaller partitions/shards and each can independently execute queries or run some programs. This way large executions can be parallelized across nodes (Partitions/Shards). Typically, there are two broad ways by which we partition/shard data: (i) Partition by key-range; or (ii) Partition by key hash. On the other hand, in order to achieve high availability, small chunks are stored to multiple nodes with multiple copies. When some of nodes are down, there will still be some copies which are available. In order to support Prefetching, the existing technique is to issue one query against specific nodes/shards and get the first batch of query result, and then against the same nodes/shards to get the next batch of query result, and so on. Obviously, the query load is always on the same nodes/shards, while other nodes/shards with the same database set will be idle.

### SUMMARY

According to an aspect of the present invention, there is a method, computer program product and/or system that performs the following operations (not necessarily in the following order): (i) receiving a data store that stores data as a plurality of shards that are stored and access by a plurality of nodes of a computer system; and (ii) analyzing, by machine logic, historical query traffic with respect to the plurality of and the plurality of shards in order to determine a plurality of query patterns that impact nodes and shards in different ways.

According to an aspect of the present invention, there is a method, computer program product and/or system that performs the following operations (not necessarily in the following order): (i) receiving a data store that stores data as a plurality of shards; and (ii) analyzing, by machine logic, historical query traffic with respect to the plurality of shards in order to determine a plurality of query patterns that impact shards in different ways.

According to an aspect of the present invention, there is a method, computer program product and/or system that performs the following operations (not necessarily in the following order): (i) receiving a data store that stores and allows access of the data on a plurality of nodes of a computer system; and (ii) analyzing, by machine logic, historical query traffic with respect to the plurality of nodes in order to determine a plurality of query patterns that impact nodes in different ways.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system.

### DETAILED DESCRIPTION

Computer technology for: (i) performing prefetching based on shard workload in NoSQL; and/or (ii) perform distribution of stored data over the various tiers of a cache memory based on shard workload in NoSQL. This can help achieve better load balance among and between the shards of a database and the respectively associated nodes on which the shards are stored. This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

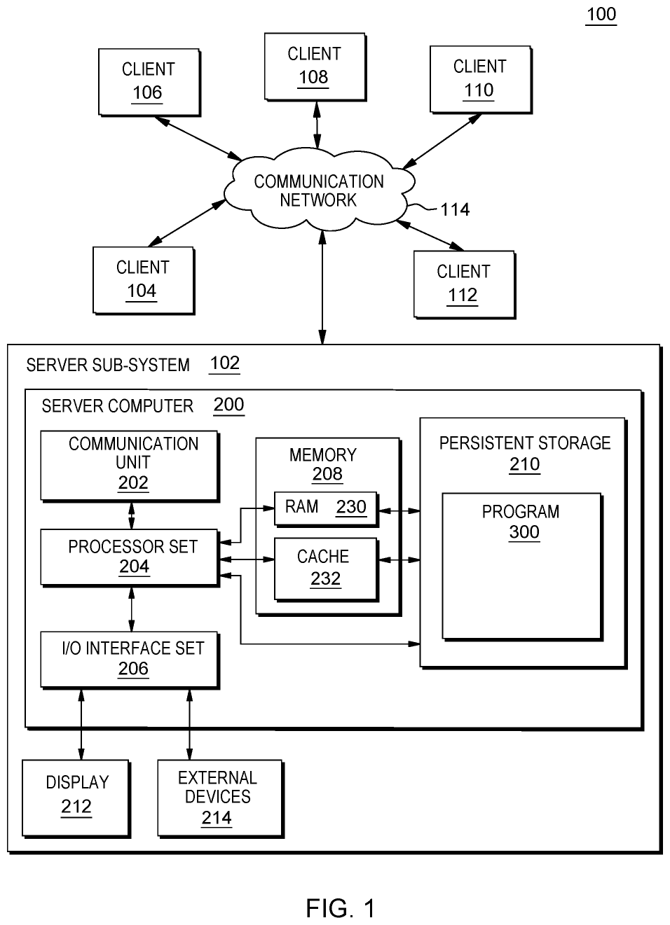

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

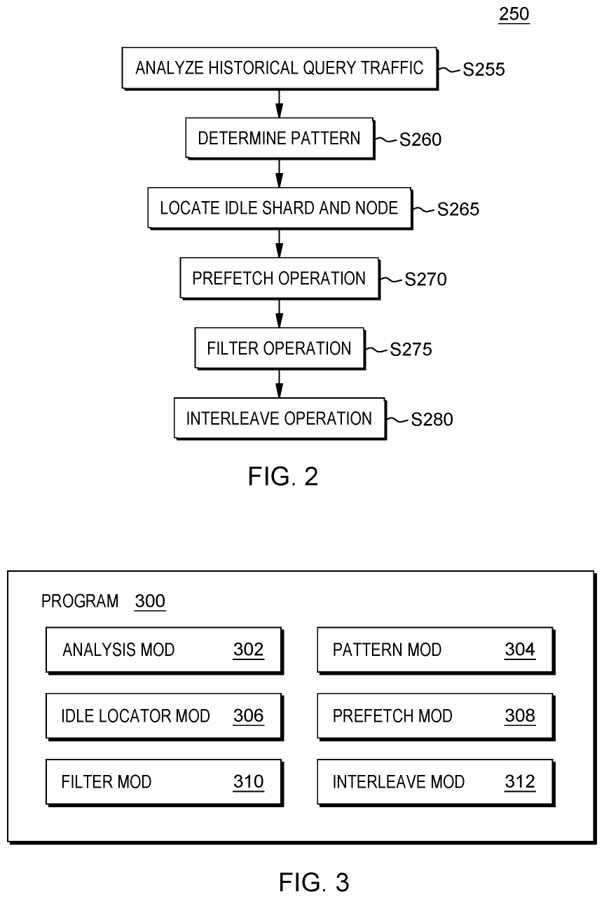

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Before moving to the various operations of flow chart 250, it is noted that computers system 100 represents a NOSQL type database, where: (i) server subsystem 102 acts as a controller for overall NOSQL database operations; (ii) each of client subsystems 104, 106, 108, 110, 112 is a node; and (iii) each node stores one or more shards of the NOSQL database.

Processing begins at operation 5255, where analysis mod 302 analyzes historical query traffic with respect to the plurality of and the plurality of shards in order to determine a plurality of query patterns that impact nodes and shards in different ways.

Processing proceeds to operation 5260, where pattern mod 304 determines a first query pattern of a plurality of query patterns that matches a received first query. This determination based on received context information (for example, hit result, queried shard, queried node, bookmark and/or timestamp) associated with the first query.

Processing proceeds to operation 5265, where idle locator mod 306 finds an idle shard and an idle node (in this example, one of client sub-systems 102, 104, 106, 108, 110, 112) based on the first query pattern determined at operation 5260.

Processing proceeds to operation 5270, where prefetch mod 308 prefetches a first response to the first query from the idle shard and through the idle node.

Processing proceeds to operation 5275 where filter mod 310 makes a filter to remove duplicate hit results from different shards.

Processing proceeds to operation 5280, where interleave mod 312 uses an interleaving shard-based query to achieve a load balance for the query that is favorable with respect to data store performance.

### III. FURTHER COMMENTS AND/OR EMBODIMENTS

Some embodiments of the present invention may include one, or more, of the following operations, features, characteristics and/or advantages: (i) performs prefetching based on shard workload in NoSQL; (ii) performs distribution of stored data over the various tiers of a cache memory based on shard workload in NoSQL; (iii) analyzes the query traffic against nodes and shards to get the typical query pattern for various different tenants; (iv) collects the distribution of stored data of the dataset in different nodes and shards; (v) captures the first batch of queries and the corresponding context including a hit result; (vi) queries shards/nodes, bookmark, and timestamp, etc. to obtain the hit result; (vii) binds the queried shards/nodes as one logical group; (viii) deduces the second logical group which contains idle shard/nodes to prefetch the result according to bookmarks and other context; (ix) stores the prefetched result into a tiered cache in one lead node of the second logical group; (x) synchronizes hit results between logical groups and makes a filter to remove duplicate hit results from the different shards; (xi) uses an interleaving shard-based query to get an improved load balance for the query; (xii) query performance can be improved by prefetching and cache; (xiii) query workload can be balanced among different nodes and shards; and/or (xiv) avoids duplicated and missing hit results.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

What is claimed is:

1. A computer-implemented method (CIM) comprising:
receiving a data store that stores data as a plurality of shards that are stored and access by a plurality of nodes of a computer system; and
analyzing, by machine logic, historical query traffic with respect to the plurality of and the plurality of shards in order to determine a plurality of query patterns that impact nodes and shards in different ways.

2. The CIM of claim 1 further comprising:
receiving a first query to the data store and corresponding first query context information;
determining a first query pattern of the plurality of query patterns that matches the first query based on the first query context information; and
finding an idle shard of the plurality of shards and an idle node of the plurality of nodes based on the first query pattern.

3. The CIM of claim 2 further comprising:
prefetching a first response to the first query from the idle shard and through the idle node.

4. The CIM of claim 3 further comprising:
making a filter to remove duplicate hit result from different shards; and
using interleaving shard-based querying techniques to achieve a load balance for a load at a time of the first query that is favorable with respect to data store performance.

5. The CIM of claim 1 wherein the data store is a NOSQL data store.

6. The CIM of claim 1 wherein the context information includes at least one of the following types of context: hit result, queried shard, queried node, bookmark and/or timestamp.

7. A computer-implemented method (CIM) comprising:
receiving a data store that stores data as a plurality of shards; and
analyzing, by machine logic, historical query traffic with respect to the plurality of shards in order to determine a plurality of query patterns that impact shards in different ways.

8. The CIM of claim 7 further comprising:
receiving a first query to the data store and corresponding first query context information;
determining a first query pattern of the plurality of query patterns that matches the first query based on the first query context information; and
finding an idle shard of the plurality of shards based on the first query pattern.

9. The CIM of claim 8 further comprising:
prefetching a first response to the first query from the idle shard.

10. The CIM of claim 9 further comprising:
making a filter to remove duplicate hit result from different shards; and
using interleaving shard-based querying techniques to achieve a load balance for a load at a time of the first query that is favorable with respect to data store performance.

11. The CIM of claim 7 wherein the data store is a NOSQL data store.

12. The CIM of claim 7 wherein the context information includes at least one of the following types of context: hit result, queried shard, queried node, bookmark and/or timestamp.

13. A computer-implemented method (CIM) comprising:
receiving a data store that stores and allows access of the data on a plurality of nodes of a computer system; and
analyzing, by machine logic, historical query traffic with respect to the plurality of nodes in order to determine a plurality of query patterns that impact nodes in different ways.

14. The CIM of claim 13 further comprising:
receiving a first query to the data store and corresponding first query context information;
determining a first query pattern of the plurality of query patterns that matches the first query based on the first query context information; and
finding an idle node of the plurality of nodes based on the first query pattern.

15. The CIM of claim 14 further comprising:
prefetching a first response to the first query through the idle node.

16. The CIM of claim 15 further comprising:
making a filter to remove duplicate hit result from different nodes; and
using interleaving shard-based querying techniques to achieve a load balance for a load at a time of the first query that is favorable with respect to data store performance.

17. The CIM of claim 13 wherein the data store is a NOSQL data store.

18. The CIM of claim 13 wherein the context information includes at least one of the following types of context: hit result, queried shard, queried node, bookmark and/or timestamp.
